(19) United States
(12) Patent Application Publication
(10) Pub. No.: US 2026/0189355 A1
(43) Pub. Date: Jul. 2, 2026

(54) METHOD AND APPARATUS FOR TRANSMITTING AND RECEIVING SIGNAL IN COMMUNICATION SYSTEM SUPPORTING SUBBAND FULL DUPLEX

(71) Applicant: ELECTRONICS AND TELECOMMUNICATIONS RESEARCH INSTITUTE, Daejeon (KR)

(72) Inventors: Hoiyoon JUNG, Daejeon (KR); Ji Hyung KIM, Daejeon (KR); Cheulsoon KIM, Daejeon (KR); Sung-Hyun MOON, Daejeon (KR); Junghoon LEE, Daejeon (KR)

(73) Assignee: ELECTRONICS AND TELECOMMUNICATIONS RESEARCH INSTITUTE, Daejeon (KR)

(21) Appl. No.: 19/326,699

(22) Filed: Sep. 11, 2025

(30) Foreign Application Priority Data
Sep. 12, 2024 (KR) 10-2024-0125098
Nov. 7, 2024 (KR) 10-2024-0157017
Feb. 6, 2025 (KR) 10-2025-0015078
Mar. 26, 2025 (KR) 10-2025-0038875
Jun. 11, 2025 (KR) 10-2025-0076222
Sep. 10, 2025 (KR) 10-2025-0128871

(51) Int. Cl. H04L 5/14; H04L 5/00

(52) U.S. Cl. CPC H04L 5/1438; H04L 5/0005; H04L 5/0044

(57) ABSTRACT

Disclosed are methods and apparatuses for transmitting signals in a communication system supporting SBFD. A method of a terminal may comprise: receiving, from a base station, scheduling information for a plurality of PDSCHs across SBFD symbols and N-SBFD symbols in different slots; determining a symbol type for the plurality of PDSCHs; and receiving the plurality of PDSCHs from the base station based on one or more symbols having the symbol type in the different slots.

### CROSS-REFERENCE TO RELATED APPLICATIONS

This application claims priority to Korean Patent Applications No. 10-2024-0125098, filed on Sep. 12, 2024, No. 10-2024-0157017, filed on Nov. 7, 2024, No. 10-2025-0015078, filed on Feb. 6, 2025, No. 10-2025-0038875, filed on Mar. 26, 2025, No. 10-2025-0076222, filed on Jun. 11, 2025, and No. 10-2025-0128871, filed on Sep. 10, 2025, with the Korean Intellectual Property Office (KIPO), the entire contents of which are hereby incorporated by reference.

### BACKGROUND

### 1. Technical Field

The present disclosure relates to a signal transmission and reception technique in a communication system, and more particularly, to a signal transmission and reception technique in a communication system supporting subband full-duplex (SBFD).

### 2. Related Art

With the advancement of information and communication technology, various wireless communication technologies have been developed. The representative wireless communication technologies may be long term evolution (LTE), LTE-advanced (LTE-A), new radio (NR), and the like specified as the 3rd generation partnership project (3GPP) standards. The LTE and/or LTE-A may be 4th generation (4G) communication technology. The NR may be a 5th generation (5G) communication technology.

The 5G communication system (e.g., communication system supporting the NR) using a higher frequency band (e.g., a frequency band of 6 GHz or above) than a frequency band (e.g., a frequency band of 6 GHz or below) of the 4G communication system is being considered for processing of soaring wireless data after commercialization of the 4G communication system (e.g., communication system supporting the LTE and/or LTE-A). The 5G communication system may support enhanced Mobile BroadBand (eMBB), Ultra Reliable Low Latency Communication (URLLC), and/or Massive Machine Type Communication (mMTC).

A communication system (e.g., 5G communication system) may support SBFD to improve efficiency and performance of a communication network. Downlink resource allocation in a communication system supporting SBFD may be performed differently from downlink resource allocation in a communication system supporting half-duplex (HD). A terminal may determine a duplex scheme (e.g., SBFD scheme or HD scheme) of a reception signal. The terminal may receive a downlink signal in a downlink resource based on the determined duplex scheme. To support the above-described operation, methods for transmitting and receiving a signal (e.g., SBFD signal) in the communication system supporting SBFD are required.

Meanwhile, the above-described technologies are described to enhance the understanding of the background of the present disclosure, and they may include non-prior arts that are not already known to those of ordinary skill in the art.

### SUMMARY

The present disclosure for resolving the above-described problems is directed to providing methods and apparatuses for transmitting and receiving signals in a communication system supporting subband full-duplex (SBFD).

A method of a terminal, according to exemplary embodiments of the present disclosure, may comprise: receiving, from a base station, scheduling information for a plurality of physical downlink shared channels (PDSCHs) across subband full-duplex (SBFD) symbols and non-SBFD (N-SBFD) symbols in different slots; determining a symbol type for the plurality of PDSCHs; and receiving the plurality of PDSCHs from the base station based on one or more symbols having the symbol type in the different slots, wherein the symbol type is SBFD symbol or N-SBFD symbol.

Each of the plurality of PDSCHs may not be mapped to both SBFD symbol(s) and N-SBFD symbol(s) within one slot.

The symbol type may be determined based on an SBFD reception configuration 1 or an SBFD reception configuration 2, one symbol type for the plurality of PDSCHs in the different slots may be determined based on the SBFD reception configuration 1, and one symbol type for at least one PDSCH among the plurality of PDSCHs in each of the different slots may be determined based on the SBFD reception configuration 2.

Based on the SBFD reception configuration 2 not being configured for the terminal, the symbol type for the plurality of PDSCHs may be determined based on the SBFD reception configuration 1.

Based on the symbol type for the plurality of PDSCHs being determined based on the SBFD reception configuration 1, the symbol type for the plurality of PDSCHs may be determined as a symbol type of an occasion for a first PDSCH among the plurality of PDSCHs. The occasion for the first PDSCH may not be mapped to both SBFD symbol(s) and N-SBFD symbol(s).

Based on the SBFD reception configuration 2 being configured for the terminal, the symbol type for the plurality of PDSCHs may be determined based on the SBFD reception configuration 2.

The method may further comprise receiving, from the base station, SBFD configuration information including at least one of time resource information or frequency resource information for SBFD symbol(s).

The time resource information may include at least one of: an index of a start slot of an SBFD subband for SBFD symbols, an index of a start symbol of the SBFD symbols in the start slot, an index of an end slot of the SBFD subband, or an index of an end symbol of the SBFD symbols in the end slot.

The frequency resource information may include at least one of: information on a position and a size of an uplink subband, information on a position and a size of a first SBFD subband for SBFD symbols, or information on a position and a size of a second SBFD subband for the SBFD symbols.

A method of a base station, according to exemplary embodiments of the present disclosure, may comprise: transmitting, to a terminal, scheduling information for a plurality of physical downlink shared channels (PDSCHs) across subband full-duplex (SBFD) symbols and non-SBFD (N-SBFD) symbols in different slots; determining a symbol type for the plurality of PDSCHs; and transmitting the plurality of PDSCHs to the terminal based on one or more symbols having the symbol type in the different slots, wherein the symbol type is SBFD symbol or N-SBFD symbol.

Each of the plurality of PDSCHs may not be mapped to both SBFD symbol(s) and N-SBFD symbol(s) within one slot.

The symbol type may be determined based on an SBFD reception configuration 1 or an SBFD reception configuration 2, one symbol type for the plurality of PDSCHs in the different slots may be determined based on the SBFD reception configuration 1, and one symbol type for at least one PDSCH among the plurality of PDSCHs in each of the different slots may be determined based on the SBFD reception configuration 2.

Based on the SBFD reception configuration 2 not being configured for the terminal, the symbol type for the plurality of PDSCHs may be determined based on the SBFD reception configuration 1.

Based on the symbol type for the plurality of PDSCHs being determined based on the SBFD reception configuration 1, the symbol type for the plurality of PDSCHs may be determined as a symbol type of an occasion for a first PDSCH among the plurality of PDSCHs.

The occasion for the first PDSCH may not be mapped to both SBFD symbol(s) and N-SBFD symbol(s).

Based on the SBFD reception configuration 2 being configured for the terminal, the symbol type for the plurality of PDSCHs may be determined based on the SBFD reception configuration 2.

The method may further comprise transmitting, to the terminal, SBFD configuration information including at least one of time resource information or frequency resource information for SBFD symbol(s).

The time resource information may include at least one of: an index of a start slot of an SBFD subband for SBFD symbols, an index of a start symbol of the SBFD symbols in the start slot, an index of an end slot of the SBFD subband, or an index of an end symbol of the SBFD symbols in the end slot.

The frequency resource information may include at least one of: information on a position and a size of an uplink subband, information on a position and a size of a first SBFD subband for SBFD symbols, or information on a position and a size of a second SBFD subband for the SBFD symbols.

According to the present disclosure, a base station can transmit to a terminal time resource information and frequency resource information for SBFD symbol(s) and/or an SBFD subband. The terminal can identify a position of the SBFD symbol(s) in the time domain based on the time resource information received from the base station. The terminal may identify a position of the SBFD subband(s) in the frequency domain based on the frequency resource information received from the base station. Meanwhile, the base station can schedule a plurality of PDSCHs across SBFD symbol(s) and N-SBFD symbol(s) in different slots. The terminal can determine a valid symbol type (e.g., SBFD symbol or N-SBFD symbol) for reception of the plurality of PDSCHs based on a predefined scheme and can receive the plurality of PDSCHs in one or more symbols having the determined valid symbol type. Based on the above-described operations, communication between the base station and the terminal in the communication system supporting SBFD can be efficiently performed, and accordingly, performance of the communication system can be improved.

### BRIEF DESCRIPTION OF DRAWINGS

FIG. 1 is a conceptual diagram illustrating exemplary embodiments of a communication network.

FIG. 2 is a block diagram illustrating exemplary embodiments of a communication node constituting a communication network.

FIG. 3 is a conceptual diagram illustrating exemplary embodiments of a system frame in a communication network.

FIG. 4 is a conceptual diagram illustrating exemplary embodiments of a subframe in a communication network.

FIG. 5 is a conceptual diagram illustrating exemplary embodiments of a slot in a communication network.

FIG. 6 is a conceptual diagram illustrating exemplary embodiments of a resource structure for SBFD communication in a communication network.

FIG. 7 is a conceptual diagram illustrating a configuration of a plurality of downlink subbands for SBFD symbols in a communication network.

FIG. 8 is a conceptual diagram illustrating exemplary embodiments of a PDSCH scheduling scheme in a communication network.

FIG. 9 is a conceptual diagram illustrating exemplary embodiments of DL-available PRBs in SBFD symbols in a communication network.

FIG. 10 is a conceptual diagram illustrating exemplary embodiments of CSI-RS resource configuration for SBFD symbols in a communication network.

FIG. 11 is a conceptual diagram illustrating exemplary embodiments of CSI reporting subband configuration for SBFD symbols in a communication network.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may be used in the same sense as a communication system. A communication network may refer to a wireless communication network, and a communication system may refer to a wireless communication system.

In the present disclosure, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In the present disclosure, signaling may be at least one of system information (SI) signaling (e.g., transmission of system information block (SIB) and/or master information block (MIB)), RRC signaling (e.g., transmission of RRC parameters and/or higher-layer parameters), MAC control element (CE) signaling, or PHY signaling (e.g., transmission of downlink control information (DCI), uplink control information (UCI), and/or sidelink control information (SCI)). A message for SI signaling may be referred to as an SI message, a message for RRC signaling may be referred to as an RRC message, a message for MAC CE signaling may be referred to as a MAC message, and a message for PHY signaling may be referred to as a PHY message. The above messages may be expressed as a first message, a second message, a third message, and so on.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

In the present disclosure, time may mean a time point, and a time point may mean time. Time and a time point may be used in the same sense. A reception time of a signal or a channel may mean a reception start time or a reception end time. A transmission time of a signal or a channel may mean a transmission start time or a transmission end time. A signal/channel may mean a signal, a channel, or a signal and a channel. A signal may be interpreted as a signal, a channel, or a signal and a channel depending on context. A channel may be interpreted as a signal, a channel, or a signal and a channel depending on context. A communication node may be interpreted as a base station, a terminal, or a base station and a terminal depending on context.

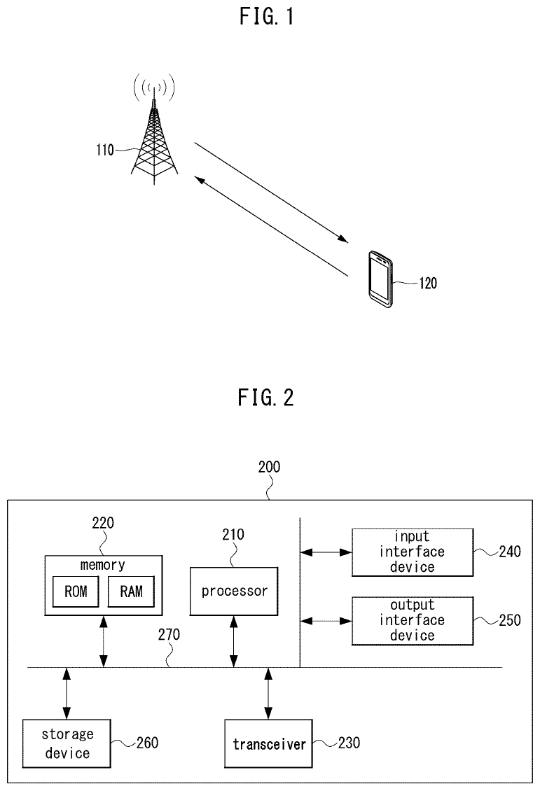

FIG. 1 is a conceptual diagram illustrating exemplary embodiments of a communication network.

Referring to FIG. 1, a base station 110 may support cellular communication (e.g., long term evolution (LTE), LTE-advance (LTE-A), LTE-A Pro, LTE-unlicensed (LTE-U), new radio (NR), and NR-unlicensed (NR-U) specified as the 3rd generation partnership project (3GPP) standards), or the like. The base station 110 may support multiple-input multiple-output (MIMO) (e.g., single-user MIMO (SU-MIMO), multi-user MIMO (MU-MIMO), massive MIMO, etc.), coordinated multipoint (COMP), carrier aggregation (CA), or the like. The terminal 120 may perform communication (e.g., uplink communication and/or downlink communication) with the base station 110.

The communication node (i.e., base station, terminal, etc.) constituting the communication network described above may support a code division multiple access (CDMA) based communication protocol, a wideband CDMA (WCDMA) based communication protocol, a time division multiple access (TDMA) based communication protocol, a frequency division multiple access (FDMA) based communication protocol, a single carrier-FDMA (SC-FDMA) based communication protocol, an orthogonal frequency division multiplexing (OFDM) based communication protocol, an orthogonal frequency division multiple access (OFDMA) based communication protocol, or the like.

Among the communication nodes, the base station may be referred to as a Node B, evolved Node B, 5G Node B (gNodeB), base transceiver station (BTS), radio base station, radio transceiver, access point, access node, transmission/reception point (Tx/Rx Point), or the like. Among the communication nodes, the terminal may be referred to as a user equipment (UE), access terminal, mobile terminal, station, subscriber station, portable subscriber station, mobile station, node, device, or the like. The communication node may have the following structure.

FIG. 2 is a block diagram illustrating exemplary embodiments of a communication node constituting a communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Hereinafter, operation methods of a communication node in a communication network will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a first terminal (e.g., transmitting terminal) is described, a corresponding second terminal (e.g., receiving terminal) may perform an operation corresponding to the operation of the first terminal. Conversely, when an operation of the second terminal is described, the corresponding first terminal may perform an operation corresponding to the operation of the second terminal.

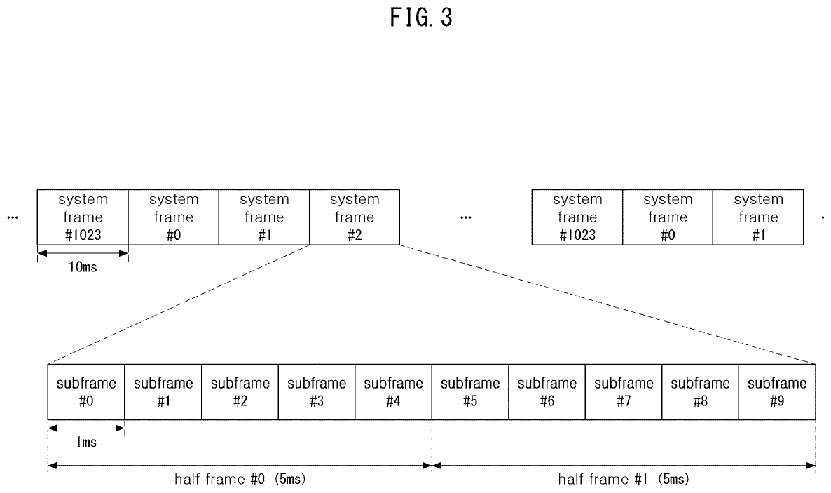

FIG. 3 is a conceptual diagram illustrating exemplary embodiments of a system frame in a communication network.

Referring to FIG. 3, time resources in a communication network may be divided into frames. For example, system frames each of which has a length of 10 milliseconds (ms) may be configured consecutively in the time domain of the communication network. System frame numbers (SFNs) may be set to #0 to #1023. In this case, 1024 system frames may be repeated in the time domain of the communication network. For example, an SFN of a system frame after the system frame #1023 may be set to #0.

One system frame may comprise two half frames, and the length of one half frame may be 5 ms. A half frame located in a starting region of a system frame may be referred to as a ‘half frame #0’, and a half frame located in an ending region of the system frame may be referred to as a ‘half frame #1’. The system frame may include 10 subframes, and the length of one subframe may be 1 ms. 10 subframes within one system frame may be referred to as ‘subframes #0 to #9’.

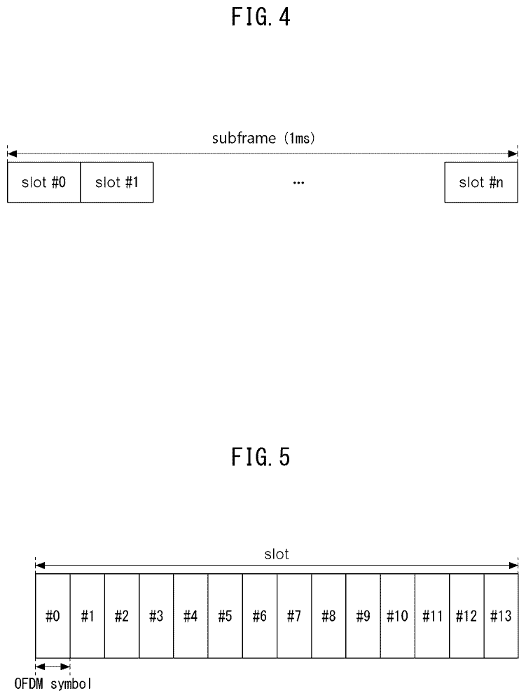

FIG. 4 is a conceptual diagram illustrating exemplary embodiments of a subframe in a communication network.

Referring to FIG. 4, one subframe may include n slots, and n may be a natural number. Accordingly, one subframe may be composed of one or more slots.

FIG. 5 is a conceptual diagram illustrating exemplary embodiments of a slot in a communication network.

Referring to FIG. 5, one slot may comprise one or more symbols. One slot shown in FIG. 5 may be composed of 14 symbols. Here, the length of the slot may vary depending on the number of symbols included in the slot and the length of the symbol. Alternatively, the length of the slot may vary according to a numerology. When a subcarrier spacing is 15 kHz (e.g., μ=0), the length of the slot may be 1 ms. In this case, one system frame may include 10 slots. When the subcarrier spacing is 30 kHz (e.g., μ=1), the length of the slot may be 0.5 ms. In this case, one system frame may include 20 slots.

When the subcarrier spacing is 60 kHz (e.g., μ=2), the length of the slot may be 0.25 ms. In this case, one system frame may include 40 slots. When the subcarrier spacing is 120 kHz (e.g., μ=3), the length of the slot may be 0.125 ms. In this case, one system frame may include 80 slots. When the subcarrier spacing is 240 kHz (e.g., μ=4), the length of the slot may be 0.0625 ms. In this case, one system frame may include 160 slots.

A symbol may be configured as a downlink (DL) symbol, a flexible (FL) symbol, or an uplink (UL) symbol. A slot consisting only of DL symbols may be referred to as a ‘DL slot’, a slot consisting only of FL symbols may be referred to as a ‘flexible (FL) slot’, and a slot consisting only of UL symbols may be referred to as a ‘UL slot’.

Reference signals may include a channel state information-reference signal (CSI-RS), a sounding reference signal (SRS), a demodulation-reference signal (DM-RS), or a phase tracking-reference signal (PT-RS). Channels may include a physical downlink control channel (PDCCH), a physical downlink shared channel (PDSCH), a physical uplink control channel (PUCCH), a physical uplink shared channel (PUSCH), a physical sidelink control channel (PSCCH), or a physical sidelink shared channel (PSSCH). In the present disclosure, a control channel may refer to a PDCCH, a PUCCH, or a PSCCH, and a data channel may refer to a PDSCH, a PUSCH, or a PSSCH.

Hereinafter, methods for transmitting and receiving data in a communication network will be described. In downlink communication, downlink data may be transmitted through a PDSCH. In uplink communication, uplink data may be transmitted through a PUSCH. In the present disclosure, a PDSCH may refer to downlink data or a resource in which the downlink data is transmitted and received, and a PUSCH may refer to uplink data or a resource in which the uplink data is transmitted and received. A base station may transmit downlink control information (DCI) including configuration information (e.g., resource allocation information, scheduling information) of a PDSCH on a PDCCH. In the present disclosure, a PDCCH may refer to a DCI (e.g., control information) or a resource in which the DCI is transmitted.

A terminal may receive the DCI on the PDCCH and identify the configuration information of the PDSCH included in the DCI. For example, the configuration information of the PDSCH may include time domain resource assignment (TDRA), frequency domain resource assignment (FDRA), information on a transmission resource of a feedback for the PDSCH, and/or modulation and coding scheme (MCS) information. The TDRA may indicate a resource region of the PDSCH in the time domain. The FDRA may indicate a resource region of the PDSCH in the frequency domain. The MCS information may indicate an MCS level or MCS index.

A base station may configure a bandwidth part (BWP) for downlink communication. The BWP may be configured differently for each terminal. The base station may notify the terminal of BWP configuration information through higher-layer signaling. The number of BWPs configured for one terminal may be one or more. The terminal may receive the BWP configuration information from the base station and may identify BWP(s) configured by the base station based on the BWP configuration information. When multiple BWPs are configured for downlink communication, the base station may activate one or more BWPs among the multiple BWPs. The base station may transmit configuration information of the activated BWP(s) to the terminal using at least one of higher-layer signaling, a medium access control (MAC) control element (CE), or a DCI. The base station may perform downlink communication using the activated BWP(s). The terminal may identify the activated BWP(s) by receiving the configuration information of the activated BWP(s) from the base station, and may perform downlink reception operations (e.g., downlink communication) in the activated BWP(s).

In the present disclosure, monitoring methods for PDCCH will be described. The terminal may perform a monitoring operation for a PDCCH in order to receive a PDSCH transmitted from the base station. The monitoring operation for the PDCCH may be referred to as a PDCCH monitoring operation. The base station may notify the terminal of configuration information for the PDCCH monitoring operation using a higher-layer message (e.g., radio resource control (RRC) message). The configuration information for the PDCCH monitoring operation may include control resource set (CORESET) information and/or search space information.

The CORESET information may include PDCCH demodulation reference signal (DMRS) information, precoding information for PDCCH, and PDCCH occasion information. The PDCCH DMRS may be a DMRS used to demodulate a PDCCH. The PDCCH occasion may be a region where a PDCCH may exist. In other words, the PDCCH occasion may be a region where a DCI may be transmitted. The PDCCH occasion information may include time resource information and/or frequency resource information of the PDCCH occasion. In the time domain, a length of the PDCCH occasion may be indicated in units of symbols. In the frequency domain, a size of the PDCCH occasion may be indicated in units of RBs (e.g., physical resource blocks (PRBs) or common resource blocks (CRBs)).

The search space information may include a CORESET identifier (ID) associated with a search space, a periodicity and/or offset of PDCCH monitoring, and the like. Each of the periodicity and offset of PDCCH monitoring may be indicated in units of slots. The search space information may further include an index of a symbol at which the PDCCH monitoring operation starts.

A communication network may perform communication based on a duplex scheme. A communication network may support a frequency division duplex (FDD) scheme. The communication network supporting the FDD scheme may use separate frequency bands for downlink communication and uplink communication. A communication network may support a time division duplex (TDD) scheme. The communication network supporting the TDD scheme may perform downlink communication or uplink communication by dividing time on the same frequency resource. Half-duplex (HD) communication may be performed in the communication network supporting the TDD scheme. The communication network supporting the HD scheme may perform either downlink communication or uplink communication in a time duration.

A communication network may perform full-duplex (FD) communication. The communication network supporting the FD scheme may perform downlink communication and uplink communication simultaneously in a time duration. In the communication network, FD communication may be performed by a base station. The base station may perform downlink communication and uplink communication simultaneously in a time duration. In the communication network, FD communication may be performed in divided frequency bands. For example, some frequency bands among frequency bands may be used for downlink communication, and other frequency bands among the frequency bands may be used for uplink communication. The FD communication described above may be referred to as subband full-duplex (SBFD) communication.

In the present disclosure, SBFD communication may refer to communication based on an SBFD scheme, FD communication may refer to communication based on the FD scheme, HD communication may refer to communication based on the HD scheme, FDD communication may refer to communication based on the FDD scheme, and TDD communication may refer to communication based on the TDD scheme. From the perspective of the base station, downlink communication may refer to downlink transmission, and uplink communication may refer to uplink reception. From the perspective of the terminal, downlink communication may refer to downlink reception, and uplink communication may refer to uplink transmission.

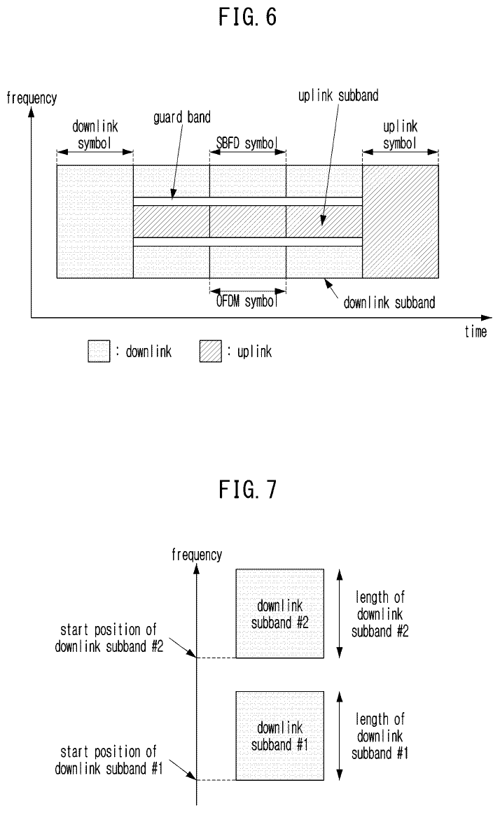

FIG. 6 is a conceptual diagram illustrating exemplary embodiments of a resource structure for SBFD communication in a communication network.

Referring to FIG. 6, in a communication network, a time resource may be configured in symbol units (e.g., OFDM symbol units). For example, a time resource may be configured as downlink symbol(s) (e.g., DL symbol(s)), uplink symbol(s) (e.g., UL symbol(s)), flexible symbol(s) (e.g., FL symbol(s)), and/or SBFD symbol(s). A downlink symbol may be a symbol in which downlink communication is performed. An uplink symbol may be a symbol in which uplink communication is performed. Downlink communication may be performed in some frequency regions of SBFD symbols, and uplink communication may be performed in other frequency regions of the SBFD symbols. The frequency regions of the SBFD symbols may be configured as a downlink subband (e.g., DL subband), an uplink subband (e.g., UL subband), and/or a guard band. In the SBFD symbols, the UL subband may also be referred to as an SBFD subband. Downlink communication may be performed in the downlink subband. One or more downlink subbands (e.g., one or two downlink subbands) may be configured in the SBFD symbols. Uplink communication may be performed in the uplink subband (e.g., SBFD subband). A guard band may exist between the uplink subband and the downlink subband. Transmission of a signal may not be performed in the guard band. One uplink subband may exist in the SBFD symbols. One or two downlink subbands may exist in the SBFD symbols.

In the communication network, SBFD symbols and/or SBFD subbands may be configured. The base station may transmit SBFD configuration information (e.g., SBFD symbol configuration information) to the terminal through signaling. The terminal may receive the SBFD configuration information (e.g., SBFD symbol configuration information) from the base station. The SBFD configuration information may include one or more of the following information.
Position of SBFD symbols in the time domain
Index of a start slot of SBFD symbols (e.g., SBFD subband) in the time domain
Index of a start symbol (e.g., start OFDM symbol) of the SBFD symbols in the start slot in the time domain
Index of an end slot of the SBFD symbols (e.g., SBFD subband) in the time domain
Index of an end symbol (e.g., end OFDM symbol) of the SBFD symbols in the end slot in the time domain
Position of a downlink subband for the SBFD symbols in the frequency domain
Start position of the downlink subband for the SBFD symbols in the frequency domain
Length (e.g., size, bandwidth) of the downlink subband for the SBFD symbols in the frequency domain
Position of an uplink subband (e.g., SBFD subband) for the SBFD symbols in the frequency domain
Start position of the uplink subband for the SBFD symbols in the frequency domain
Length (e.g., size, bandwidth) of the uplink subband for the SBFD symbols in the frequency domain
Position of a guard band for the SBFD symbols in the frequency domain
Start position of the guard band for the SBFD symbols in the frequency domain
Length (e.g., size, bandwidth) of the guard band for the SBFD symbols in the frequency domain

The time domain may refer to a time region, and the frequency domain may refer to a frequency region. A start slot of SBFD symbols (e.g., SBFD subband) may refer to a slot in which the first SBFD symbol is located in the time domain. A start symbol of the SBFD symbols may refer to a symbol in which the first SBFD symbol (e.g., the first SBFD symbol in the start slot of the SBFD symbols) is located in the time domain. The start slot may be the first slot, and the start symbol may be the first symbol. An end slot of the SBFD symbols (e.g., SBFD subband) may refer to a slot in which the last SBFD symbol is located in the time domain. An end symbol of the SBFD symbols may refer to a symbol in which the last SBFD symbol (e.g., the last SBFD symbol in the end slot of the SBFD symbols) is located in the time domain. The end slot may refer to the last slot, and the end symbol may refer to the last symbol. A symbol may refer to an OFDM symbol.

In the time domain, the position of SBFD symbols may be indicated based on a scheme of indicating symbol(s) corresponding to the SBFD symbols among symbols within a slot and/or a scheme of indicating whether each symbol in the slot corresponds to an SBFD symbol. In another method, positions of downlink symbols and uplink symbols within a slot may be indicated, and remaining symbol(s) within the slot not indicated as downlink symbol(s) or uplink symbol(s) may be regarded as SBFD symbol(s). The position of SBFD symbols within a slot in the time domain may be after downlink symbol(s). The position of SBFD symbols within a slot in the time domain may be before uplink symbol(s). The position of SBFD symbols within a slot in the time domain may be between a time duration in which downlink symbol(s) exist and a time duration in which uplink symbol(s) exist.

A base station may transmit TDD configuration information (e.g., tdd-UL-DL-ConfigurationCommon) to a terminal through signaling. The terminal may receive the TDD configuration information from the base station. The TDD configuration information may indicate positions of downlink symbols and/or flexible symbols. When an uplink subband is configured in downlink symbol(s) indicated by the TDD configuration information or when an uplink subband and a downlink subband are configured in flexible symbol(s) indicated by the TDD configuration information, the downlink symbol(s) or the flexible symbol(s) may be defined as SBFD symbol(s). The terminal may perform signal transmission (e.g., uplink communication) in SBFD symbols among the downlink symbols indicated by the TDD configuration information. When an uplink subband is not configured in downlink symbol(s) indicated by the TDD configuration information or when an uplink subband and a downlink subband are not configured in flexible symbol(s) indicated by the TDD configuration information, the downlink symbol(s) or the flexible symbol(s) may be defined as non-SBFD (N-SBFD) symbols. A symbol type may be determined as SBFD symbol or N-SBFD symbol. For example, the symbol type may be determined based on the TDD configuration information. The determined symbol type may not be updated (e.g., changed) by other information.

In the frequency domain, the position of the downlink subband for SBFD symbols may be indicated based on the lowest frequency position of the downlink subband (or a start position of the downlink subband in the frequency domain) and the length (e.g., size, bandwidth) of the downlink subband in the frequency domain. The downlink subband may be indicated in resource block (RB) units or subcarrier units. When one or more downlink subbands exist in SBFD symbols, the position(s) of one or more downlink subbands may be indicated to the terminal.

When a plurality of downlink subbands (e.g., downlink subband #1 and downlink subband #2) exist in SBFD symbols, the length (e.g., size, bandwidth) of the downlink subband #1 in the frequency domain and the length (e.g., size, bandwidth) of the downlink subband #2 in the frequency domain may be configured to be identical. The lowest frequency position of each of the plurality of downlink subbands or the start position of each of the plurality of downlink subbands in the frequency domain may be independently indicated to the terminal. The length of each of the plurality of downlink subbands in the frequency domain may be indicated to the terminal as one value.

In another example, when a plurality of downlink subbands (e.g., downlink subband #1 and downlink subband #2) exist in SBFD symbols, the length of the downlink subband #1 in the frequency domain and the length of the downlink subband #2 in the frequency domain may be configured independently from each other. In other words, the length of each of the plurality of downlink subbands in the frequency domain may be independently indicated to the terminal. The length of the downlink subband #1 may be the same as or different from the length of the downlink subband #2.

The position of an uplink subband (e.g., SBFD subband) for SBFD symbols in the frequency domain may be indicated based on the lowest frequency position of the uplink subband (or the start position of the uplink subband in the frequency domain) and the length (e.g., size, bandwidth) of the uplink subband in the frequency domain. The uplink subband may be indicated in RB units or subcarrier units.

The position of a guard band for SBFD symbols in the frequency domain may be determined based on the position of the downlink subband and the position of the uplink subband. For example, the communication node (e.g., base station and/or terminal) may regard (e.g., determine) the remaining frequency band in the frequency region excluding the downlink subband(s) and the uplink subband as a guard band.

The base station may transmit SBFD configuration information (e.g., SBFD symbol configuration information) to the terminal through a system information block (SIB). The SIB may be information transmitted in common to terminals in a cell. The base station may transmit the SBFD configuration information to the terminal through a higher layer message (e.g., RRC configuration). The higher layer message may be information transmitted to an individual terminal. Alternatively, the higher layer message may be information transmitted in common to terminals in a cell. The base station may transmit tdd-UL-DL-ConfigurationCommon including the SBFD configuration information to the terminal. The terminal may receive the SBFD configuration information through signaling of the base station, may identify (e.g., determine) SBFD symbols and/or N-SBFD symbols in the time domain based on the SBFD configuration information, and may identify (e.g., determine) downlink subband(s), an uplink subband, and/or a guard band for the SBFD symbols in the frequency domain based on the SBFD configuration information.

The base station may transmit the SBFD configuration information (e.g., SBFD symbol configuration information) to the terminal through the SIB and the higher layer message (e.g., RRC configuration). The terminal may receive the SIB from the base station and may identify the SBFD configuration information included in the SIB. The terminal may receive the higher layer message from the base station and may identify the SBFD configuration information included in the higher layer message. When the SBFD configuration information is received through the SIB and the higher layer message, the terminal may identify (e.g., determine) SBFD symbols, N-SBFD symbols, downlink subband(s) for the SBFD symbols, an uplink subband for the SBFD symbols, and/or a guard band for the SBFD symbols based on the SBFD configuration information received through the higher layer message. In other words, when SBFD configuration information is received through both the SIB and the higher layer message, the terminal may ignore the SBFD configuration information received through the SIB. The SBFD configuration information included in the higher layer message may take precedence over the SBFD configuration information included in the SIB.

The terminal may receive the SBFD configuration information and may identify SBFD symbols and N-SBFD symbols based on the SBFD configuration information. The terminal may receive a slot format indicator (SFI). The terminal may apply the SFI to the N-SBFD symbols. The terminal may not apply the SFI to the SBFD symbols. The terminal may ignore the SFI for the SBFD symbols.

Hereinafter, precoding methods for downlink transmission will be described. A base station may perform downlink transmission by applying the same precoding to one or more consecutive physical resource blocks (PRBs). A group of PRBs to which the same precoding is applied may be referred to as a precoding resource block group (PRG). A PRG may include two or four PRBs. Alternatively, a PRG may span a wideband. A PRG size may be defined as P. P may be a natural number. In a given bandwidth (e.g., a frequency band), precoding for downlink transmission may be performed in units of P PRBs. A PRG applied over a wideband may mean that the same precoding is applied for downlink transmission in the given bandwidth. In an environment (e.g., a communication network) in which the same transmission configuration indicator (TCI) and/or the same quasi co-location (QCL) is assumed, the same precoding may be applied.

FIG. 7 is a conceptual diagram illustrating a configuration of a plurality of downlink subbands for SBFD symbols in a communication network.

Referring to FIG. 7, a plurality of downlink subbands (e.g., downlink subband #1 and downlink subband #2) for SBFD symbol(s) may exist in the frequency domain. The plurality of downlink subbands may not be adjacent in the frequency domain. A downlink subband may include one or more PRBs. PRG grouping may be performed for the downlink subband, and the PRG grouping may be performed in units of the PRG size P. A size of each PRG except for the first PRG and the last PRG among PRGs classified based on PRB indexes may be P. When an index of the first PRB of the downlink subband is N, a size K of the first PRG may be determined based on Equation 1 below.

$$K = P - N ( mod ) P \qquad [ Equation 1 ]$$

A size L of the last PRG may be determined based on Equation 2 below. N may be the index of the first PRB of the downlink subband. M may be a number of PRBs. For example, M may be a size of the downlink subband. P may be the PRG size as a unit of PRG grouping.

$$L = P , if ( N + M ) mod P = 0 L = ( N + M ) mod P , if ( N + M ) mod P \neq 0 \qquad [ Equation 2 ]$$

A base station may transmit, to a terminal, at least one of the PRG size P, the index N of the first PRB of the downlink subband, or the size M of the downlink subband through signaling (e.g., system information block (SIB), higher layer message, or RRC configuration). The terminal may identify at least one of the PRG size P, the index N of the first PRB of the downlink subband, or the size M of the downlink subband based on the signaling from the base station.

When a plurality of downlink subbands (e.g., downlink subband #1 and downlink subband #2) exist in SBFD symbols, PRG grouping for the plurality of downlink subbands may be performed as follows.

A communication node (e.g., the base station and/or the terminal) may individually perform PRG grouping for the plurality of downlink subbands (e.g., downlink subband #1 and downlink subband #2) based on Equation 1 and/or Equation 2.

When an index of the first PRB of the downlink subband #1 is N1 and a size of the downlink subband #1 is M1, the communication node may determine a size K1 of the first PRG of the downlink subband #1 by substituting N1 for N in Equation 1, and the communication node may determine a size L1 of the last PRG of the downlink subband #1 by substituting N1 and M1 for N and M, respectively, in Equation 2.

When an index of the first PRB of the downlink subband #2 is N2 and a size of the downlink subband #2 is M2, the communication node may determine a size K2 of the first PRG of the downlink subband #2 by substituting N2 for N in Equation 1, and the communication node may determine a size L2 of the last PRG of the downlink subband #2 by substituting N2 and M2 for N and M, respectively, in Equation 2.

In another exemplary embodiment, the communication node may perform PRG grouping for the downlink subband #1, and the PRG grouping for the downlink subband #1 may be equally applied to the downlink subband #2. In other words, the same PRG grouping may be applied to the downlink subband #1 and the downlink subband #2.

When the index of the first PRB of the downlink subband #1 is N1 and the size of the downlink subband #1 is M1, the communication node may determine the size K1 of the first PRG of the downlink subband #1 by substituting N1 for N in Equation 1, and the communication node may determine the size L1 of the last PRG of the downlink subband #1 by substituting N1 and M1 for N and M, respectively, in Equation 2. When the PRG grouping for the downlink subband #1 is performed as described above, the communication node may set the size K2 of the first PRG of the downlink subband #2 to be the same as K1, and may set the size L2 of the last PRG of the downlink subband #2 to be the same as L1.

In another exemplary embodiment, the communication node may perform PRG grouping for the downlink subband #1, and may configure PRG groups for the downlink subband #2 by extending the PRG grouping for the downlink subband #1.

When the index of the first PRB of the downlink subband #1 is N1 and the size of the downlink subband #1 is M1, the communication node may determine the size K1 of the first PRG of the downlink subband #1 by substituting N1 for N in Equation 1, and may determine the size L1 of the last PRG of the downlink subband #1 by substituting N1 and M1 for N and M, respectively, in Equation 2. When the PRG grouping for the downlink subband #1 is performed as described above, the communication node may set the size K2 of the first PRG of the downlink subband #2 to be the same as P-K1, and may determine the size L2 of the last PRG of the downlink subband #2 based on Equation 3 below.

$$L 2 = P , if ( N 2 + M 2 ) mod P = 0 L 2 = ( N 2 + M 2 ) mod P , if ( N 2 + M 2 ) mod P \neq 0 \qquad [ Equation 3 ]$$

In Equation 3, N2 may be the index of the first PRB of the downlink subband #2, and M2 may be the size of the downlink subband #2. In other words, M2 may be a number of PRBs included in the downlink subband #2.

The base station may indicate (e.g., transmit) PRG size information to the terminal through signaling (e.g., RRC configuration or DCI). The terminal may receive the PRG size information based on the signaling from the base station. The base station may transmit a signaling (e.g., RRC configuration) indicating a method of indicating the PRG size information to the terminal. The method of indicating the PRG size information may be classified into “a method of indicating PRG size information through RRC configuration” or “a method of indicating PRG size information through DCI”. The terminal may identify the method of indicating PRG size information based on the signaling from the base station, and may receive the PRG size information from the base station based on the indicating method (e.g., RRC configuration or DCI).

When the PRG size (e.g., PRG size information) is indicated through RRC configuration, the terminal may identify precoding information for downlink transmission using the PRG size information indicated by the RRC configuration. When the PRG size (e.g., PRG size information) is indicated through DCI, a meaning of a PRG size indicator included in the DCI may be determined based on an RRC configuration.

The PRG size information may be configured as a first set and a second set. The base station may transmit, to the terminal through signaling (e.g., RRC configuration), information of the first set and the second set for the PRG size information. The terminal may receive information of the first set and the second set based on the signaling from the base station. The first set may be configured with one or more values. The one or more values may be used to indicate the PRG size. The second set may be configured with one value. The one value may be used to indicate the PRG size.

When the PRG size indicator included in the DCI is set to a first value (e.g., 0), the terminal may determine the PRG size based on the value of the second set. For example, the terminal may regard the PRG size as being the same as the value of the second set. When the first set is configured with one value and the PRG size indicator included in the DCI is set to a second value (e.g., 1), the terminal may determine the PRG size based on the value of the first set. For example, the terminal may regard the PRG size as being the same as the value of the first set. When the first set is configured with two values and the PRG size indicator included in the DCI is set to the second value (e.g., 1), the terminal may determine the PRG size based on the value(s) of the first set. For example, the terminal may identify (e.g., determine) the PRG size based on a downlink scheduling bandwidth.

When the first set is configured with two values, the two values may be configured as (2, wideband) or (4, wideband). ‘2’ may indicate that the PRG size is 2. ‘4’ may indicate that the PRG size is 4. ‘wideband’ may indicate that a PRG is applied over a wideband. When the two values of the first set are configured as (2, wideband) or (4, wideband), the PRG size indicator included in the DCI is set to the second value (e.g., 1), scheduled PRBs are contiguous, and a size of the scheduled PRBs is greater than one half of a given frequency bandwidth, the terminal may regard that the PRG size P is the same as the size of the scheduled PRBs.

When the two values of the first set are configured as (2, wideband) or (4, wideband), the PRG size indicator included in the DCI is set to the second value (e.g., 1), the scheduled PRBs are contiguous, and the size of the scheduled PRBs is not greater than one half of the given frequency bandwidth, the terminal may determine the PRG size P as 2 or 4. In this case, when the two values of the first set are configured as (2, wideband), the terminal may determine the PRG size P as 2. When the two values of the first set are configured as (4, wideband), the terminal may determine the PRG size P as 4. The given frequency bandwidth may be a bandwidth of a downlink BWP. Alternatively, the given frequency bandwidth may be a bandwidth of downlink available PRBs. Alternatively, the given frequency bandwidth may be a bandwidth of a downlink subband.

Some PRBs among one or more PRBs constituting one PRG may exist within a downlink subband, and other PRBs among the one or more PRBs may exist outside the downlink subband. The PRG configured as described above may be referred to as a partial PRG. The terminal may perform downlink reception in PRB(s) existing within the downlink subband among the PRBs constituting the partial PRG. The terminal may perform channel estimation for the PRB(s) existing within the downlink subband among the PRBs constituting the partial PRG. The terminal may not perform downlink reception in PRB(s) not existing within the downlink subband among the PRBs constituting the partial PRG. The terminal may not perform channel estimation for the PRB(s) not existing within the downlink subband among the PRBs constituting the partial PRG.

The terminal may report, to the base station, partial PRG processing capability information for SBFD symbols. The terminal may transmit, to the base station, a UE capability report including information indicating a number (e.g., a maximum number) of partial PRGs processable by the terminal in an SBFD symbol. The base station may receive the UE capability report from the terminal, and may identify, based on the information included in the UE capability report, the number (e.g., the maximum number) of partial PRGs processable by the terminal in an SBFD symbol.

Hereinafter, methods of transmitting and receiving signals in SBFD symbols and/or N-SBFD symbols will be described. Among terminals, a terminal capable of recognizing SBFD symbols may be an SBFD-aware terminal. For convenience, the SBFD-aware terminal may be referred to as an SBFD terminal. Among terminals, a terminal not capable of recognizing SBFD symbols may be referred to as a legacy terminal. In the present disclosure, a terminal may be interpreted as an SBFD terminal or a legacy terminal according to a context.

Uplink communication for an SBFD terminal may be performed in SBFD symbol(s) or N-SBFD symbol(s) within one slot. In other words, uplink communication for an SBFD terminal may not be performed across SBFD symbol(s) and N-SBFD symbol(s) within one slot. The terminal may not expect that an uplink channel/signal is mapped to SBFD symbol(s) and N-SBFD symbol(s) within one slot. Downlink communication for an SBFD terminal may be performed in SBFD symbol(s) or N-SBFD symbol(s) within one slot. In other words, downlink communication for an SBFD terminal may not be performed across SBFD symbol(s) and N-SBFD symbol(s) within one slot. The terminal may not expect that a downlink channel/signal is mapped to SBFD symbol(s) and N-SBFD symbol(s) within one slot. The SBFD terminal may not receive a PDSCH existing across SBFD symbol(s) and N-SBFD symbol(s) within one slot. Each of uplink communication and downlink communication for the SBFD terminal may be performed in symbol(s) having the same type within one slot. Each of uplink communication and downlink communication for the SBFD terminal may not be performed in symbol(s) having different types within one slot.

Uplink communication (e.g., PUSCH transmission, PUCCH transmission) or downlink communication (e.g., PDSCH reception, PDCCH reception) may be scheduled in a plurality of slots (e.g., different slots), and each of the plurality of slots may include SBFD symbol(s) and/or N-SBFD symbol(s). The SBFD terminal may determine, based on configuration of the base station, whether to perform communication (e.g., uplink communication and/or downlink communication) across SBFD symbol(s) and N-SBFD symbol(s) in the plurality of slots.

The base station may indicate to the terminal, through signaling (e.g., higher layer message or RRC configuration), a configuration (hereinafter referred to as ‘SBFD transceiving configuration 1’) indicating that communication is not performed across SBFD symbol(s) and N-SBFD symbol(s) in a plurality of slots. An SBFD reception configuration 1 may indicate communication based on symbol(s) having the same symbol type in the plurality of slots. The SBFD transceiving configuration 1 may mean the SBFD reception configuration 1 and/or an SBFD transmission configuration 1. The base station may indicate to the terminal, through signaling (e.g., higher layer message or RRC configuration), a configuration (hereinafter referred to as ‘SBFD transceiving configuration 2’) indicating that communication is performed across SBFD symbol(s) and N-SBFD symbol(s) in a plurality of slots. When the SBFD transceiving configuration 2 is indicated, the terminal may perform communication using SBFD symbols in some slots among the plurality of slots, and may perform communication using N-SBFD symbols in other slots among the plurality of slots. The SBFD transceiving configuration 2 may mean an SBFD reception configuration 2 and/or an SBFD transmission configuration 2.

The terminal may receive the SBFD transceiving configuration 1 or the SBFD transceiving configuration 2 based on signaling of the base station. A higher layer message indicating the SBFD transceiving configuration 1 or the SBFD transceiving configuration 2 may be configured for a cell (e.g., a serving cell). In other words, the higher layer message indicating the SBFD transceiving configuration 1 or the SBFD transceiving configuration 2 may be configured as cell-specific. For example, the SBFD transceiving configuration 1 or the SBFD transceiving configuration 2 may be commonly indicated for terminals in the cell.

In another exemplary embodiment, a higher layer message indicating the SBFD transceiving configuration 1 or the SBFD transceiving configuration 2 may be configured as UE-specific. For example, the SBFD transceiving configuration 1 or the SBFD transceiving configuration 2 may be indicated for each terminal. In another exemplary embodiment, the higher layer message indicating the SBFD transceiving configuration 1 or the SBFD transceiving configuration 2 may be configured for each channel or signal. For example, the SBFD transceiving configuration 1 or the SBFD transceiving configuration 2 may be indicated for each channel or signal transmitted and received by the terminal. In another exemplary embodiment, a higher layer message indicating the SBFD transceiving configuration 1 or the SBFD transceiving configuration 2 may be configured for each BWP (e.g., a BWP of the terminal). For example, the SBFD transceiving configuration 1 or the SBFD transceiving configuration 2 may be indicated for each downlink BWP or for each uplink BWP. When one or more downlink BWPs and/or one or more uplink BWPs are configured for the terminal, the SBFD transceiving configuration 1 or the SBFD transceiving configuration 2 may be indicated for each of the BWPs.

The SBFD reception configuration 1 or the SBFD reception configuration 2 for a downlink BWP of the terminal may be indicated. The SBFD transmission configuration 1 or the SBFD transmission configuration 2 for an uplink BWP of the terminal may be indicated. The SBFD reception configuration may include a reception configuration among SBFD transceiving configurations. The SBFD transmission configuration may include a transmission configuration among SBFD transceiving configurations. When the SBFD transceiving configuration 1 or the SBFD transceiving configuration 2 is indicated for a BWP, the SBFD transceiving configuration may be applied for downlink communication (e.g., PDSCH reception, PDCCH reception) or uplink communication (e.g., PUSCH transmission, PUCCH transmission) within the BWP. For downlink communication and/or uplink communication performed outside the BWP, the SBFD transceiving configuration 1 and/or the SBFD transceiving configuration 2 may not be applied.

A default SBFD transceiving configuration may be the SBFD transceiving configuration 1. When the SBFD transceiving configuration 1 is indicated from the base station, the terminal may perform communication based on the SBFD transceiving configuration 1. Alternatively, when the SBFD transceiving configuration 2 is not indicated from the base station, the terminal may perform communication based on the SBFD transceiving configuration 1 (e.g., the default SBFD transceiving configuration). When the SBFD transceiving configuration 2 is indicated by the base station, the terminal may perform communication based on the SBFD transceiving configuration 2. When the terminal does not receive a separate SBFD transceiving configuration from the base station, the terminal may perform communication using the SBFD transceiving configuration 1 as the default SBFD transceiving configuration. The indication of the SBFD transceiving configuration 1 by the base station may mean that a separate SBFD transceiving configuration is not received from the base station. The indication of the SBFD transceiving configuration 1 by the base station may mean that the SBFD transceiving configuration 2 is not received from the base station.

In another exemplary embodiment, an SBFD transceiving configuration (e.g., an SBFD transceiving configuration indicated through a higher-layer message) may differ according to a scheduling scheme. The scheduling scheme may be classified into a semi-static scheduling (SPS) scheme, a configured grant (CG) scheduling scheme, or a dynamic scheduling scheme. For example, the SBFD transceiving configuration 1 may be indicated to the terminal for communication based on the SPS scheme or the CG scheduling scheme, and the SBFD transceiving configuration 2 may be indicated to the terminal for communication based on the dynamic scheduling scheme.

For communication across SBFD symbol(s) and N-SBFD symbol(s) in multiple slots, the base station may instruct the terminal to perform communication through symbols (e.g., SBFD symbols or N-SBFD symbols) having the same symbol type within each slot. The terminal may identify the instruction from the base station. A communication node (e.g., the base station and/or the terminal) may perform communication using SBFD symbol(s) or N-SBFD symbol(s) within each slot. The terminal may determine a symbol type for communication based on different criteria for each scheduling scheme of the base station. The communication may be interpreted, depending on a context, as uplink communication, downlink communication, or both uplink communication and downlink communication. The symbol type for communication may be determined not only by the terminal but also by the base station. The base station may determine a symbol type for communication in the same or a similar manner as the terminal and may perform communication with the terminal in one or more symbols having the determined symbol type.

In the dynamic scheduling scheme based on DCI, the terminal may determine a symbol type for communication based on a type (e.g., SBFD symbol or N-SBFD symbol) of the first symbol indicated through scheduling information (e.g., scheduling DCI) in the time domain. For example, when the scheduling information indicates a resource (e.g., a time resource) from symbol #N to symbol #M and a symbol type of symbol #N (e.g., a symbol type of the first occasion) is SBFD symbol, the terminal may perform communication using SBFD symbol(s). Each of N and M may be a natural number, and N may be smaller than M. In another example, when the scheduling information indicates a resource (e.g., a time resource) from symbol #N to symbol #M and a symbol type of symbol #N (e.g., a symbol type of the first occasion) is N-SBFD symbol, the terminal may perform communication using N-SBFD symbol(s). In the present disclosure, an occasion may refer to a PDCCH occasion, a PDSCH occasion, a PUCCH occasion, or a PUSCH occasion. The terminal may not expect that the first occasion is mapped to both SBFD symbol(s) and N-SBFD symbol(s). In other words, the first occasion may not be mapped to both SBFD symbol(s) and N-SBFD symbol(s).

In the SPS scheduling scheme or the CG scheduling scheme, a symbol type for communication (e.g., PDSCH reception or PUSCH transmission) may be determined based on an RRC configuration. The base station may transmit SPS scheduling information (e.g., SPS configuration information) or CG scheduling information (e.g., CG configuration information) to the terminal through signaling (e.g., RRC configuration). The terminal may receive the SPS scheduling information or the CG scheduling information through signaling from the base station. The SPS scheduling information may include information on a symbol type for PDSCH reception. The CG scheduling information may include information on a symbol type for PUSCH transmission. A communication node (e.g., the base station and/or the terminal) may perform PDSCH reception or PUSCH transmission in symbol(s) (e.g., SBFD symbol(s) or N-SBFD symbol(s) having the symbol type indicated through the scheduling information.

In another exemplary embodiment, a symbol type for PDSCH reception may be determined based on a symbol type for the first PDSCH reception (e.g., a symbol type of the first PDSCH occasion) after a time when SPS scheduling is activated. A symbol type for PUSCH transmission may be determined based on a symbol type for the first PUSCH transmission (e.g., a symbol type of the first PUSCH occasion) after a time when CG scheduling is activated. For example, when an activation message for SPS scheduling is received in slot #N, and a position of the first PDSCH reception (e.g., the first PDSCH occasion) after receiving the activation message corresponds to an SBFD symbol, the terminal may interpret that the SPS scheduling is scheduling for SBFD symbols and may perform PDSCH reception in SBFD symbols (e.g., SBFD symbols in multiple slots). When an activation message for SPS scheduling is received in slot #N, and a position of the first PDSCH reception (e.g., the first PDSCH occasion) after receiving the activation message corresponds to an N-SBFD symbol, the terminal may interpret that the SPS scheduling is scheduling for N-SBFD symbols and may perform PDSCH reception in N-SBFD symbols (e.g., N-SBFD symbols in multiple slots). The base station may determine a valid symbol type based on the above-described method and may perform communication based on the SPS scheduling in one or more symbols having the valid symbol type.

In another example, when an activation message for CG scheduling is received in slot #N, and a position of the first PUSCH transmission (e.g., the first PUSCH occasion) after receiving the activation message corresponds to an SBFD symbol, the terminal may interpret that the CG scheduling is scheduling for SBFD symbols and may perform PUSCH transmission in SBFD symbols (e.g., SBFD symbols in multiple slots). When an activation message for CG scheduling is received in slot #N, and a position of the first PUSCH transmission (e.g., the first PUSCH occasion) after receiving the activation message corresponds to an N-SBFD symbol, the terminal may interpret that the CG scheduling is scheduling for N-SBFD symbols and may perform PUSCH transmission in N-SBFD symbols (e.g., N-SBFD symbols in multiple slots). The base station may determine a valid symbol type based on the above-described method and may perform communication based on the CG scheduling in one or more symbols having the valid symbol type.

In another exemplary embodiment, the base station may instruct the terminal to perform communication across SBFD symbol(s) and N-SBFD symbol(s) in multiple slots. The terminal may perform communication in symbols (e.g., SBFD symbols or N-SBFD symbols) having one symbol type within each slot based on the instruction from the base station. The terminal may perform communication using symbols having different symbol types in different slots. For example, the terminal may perform communication using SBFD symbols in a first slot, and the terminal may perform communication using N-SBFD symbols in a second slot.

The base station may instruct the terminal to perform one exemplary embodiment (e.g., one of the above-described methods) among the above-described exemplary embodiments. The terminal may perform communication across SBFD symbol(s) and N-SBFD symbol(s) in multiple slots based on the instruction from the base station. The base station may expect to perform communication with the terminal across SBFD symbol(s) and N-SBFD symbol(s) in multiple slots based on the instruction.

Hereinafter, communication methods in SBFD symbols based on a frequency resource allocation method will be described. Frequency resources for uplink communication may be allocated to the terminal. Frequency resources for downlink communication may be allocated to the terminal. The frequency resources may be allocated based on two methods. In a frequency resource allocation method 1, a bitmap may be used to allocate frequency resources. Each bit in the bitmap may indicate whether one or more PRBs are allocated for communication. In a frequency resource allocation method 2, a resource indication value (RIV) may be used to allocate frequency resources. The RIV may indicate a start position of a frequency resource allocated for communication and a length (e.g., a size or a bandwidth) of the frequency resource. Communication in SBFD symbols may be performed differently according to the frequency resource allocation method.

When the SBFD transceiving configuration 1 is indicated to the terminal and frequency resources are scheduled based on the frequency resource allocation method 1, the terminal may perform communication (e.g., downlink reception or uplink transmission) through DL-available PRBs or UL-available PRBs in SBFD symbols. The terminal may not perform communication in resources that do not belong to the DL-available PRBs or the UL-available PRBs among the resources indicated through the frequency resource allocation method 1. For example, when an RBG (RB group) including one or more RBs is allocated to the terminal through the frequency resource allocation method 1, and some PRBs in the RBG exist within DL-available PRBs or UL-available PRBs, and other PRBs in the RBG do not exist within DL-available PRBs or UL-available PRBs, the terminal may use some PRBs existing within the DL-available PRBs for downlink communication and may use some PRBs existing within the UL-available PRBs for uplink communication. The terminal may not use other PRBs that do not exist within the DL-available PRBs for downlink communication, and the terminal may not use PRBs that do not exist within the UL-available PRBs for uplink communication.

To determine a number of PRBs for determining a transport block size (TBS) of downlink communication or uplink communication, the terminal may use PRBs that exist within DL-available PRBs or UL-available PRBs among resources indicated through the frequency resource allocation method 1. To determine a number of PRBs for determining a TBS of downlink communication or uplink communication, the terminal may not consider PRBs that do not exist within DL-available PRBs or UL-available PRBs among resources indicated through the frequency resource allocation method 1. For example, when an RBG including one or more RBs is allocated through the frequency resource allocation method 1, and some PRBs in the RBG exist within DL-available PRBs or UL-available PRBs while other PRBs in the RBG do not exist within DL-available PRBs or UL-available PRBs, the terminal may determine a number of PRBs for determining a TBS of downlink communication or uplink communication by considering the PRBs that exist within DL-available PRBs or UL-available PRBs. The terminal may not use the PRBs that do not exist within DL-available PRBs or UL-available PRBs for determining a number of PRBs for determining the TBS of downlink communication or uplink communication.

When the SBFD transceiving configuration 1 is indicated to the terminal and downlink scheduling is performed through the frequency resource allocation method 2, the terminal may perform downlink reception through DL-available PRBs in SBFD symbols. The terminal may not perform downlink reception in resources that do not exist within DL-available PRBs among resources indicated through the frequency resource allocation method 2. To determine a number of PRBs for determining a TBS of downlink communication, the terminal may use PRBs that exist within DL-available PRBs among resources indicated through the frequency resource allocation method 2. To determine a number of PRBs for determining a TBS of downlink communication, the terminal may not consider PRBs that do not exist within DL-available PRBs among resources indicated through the frequency resource allocation method 2.

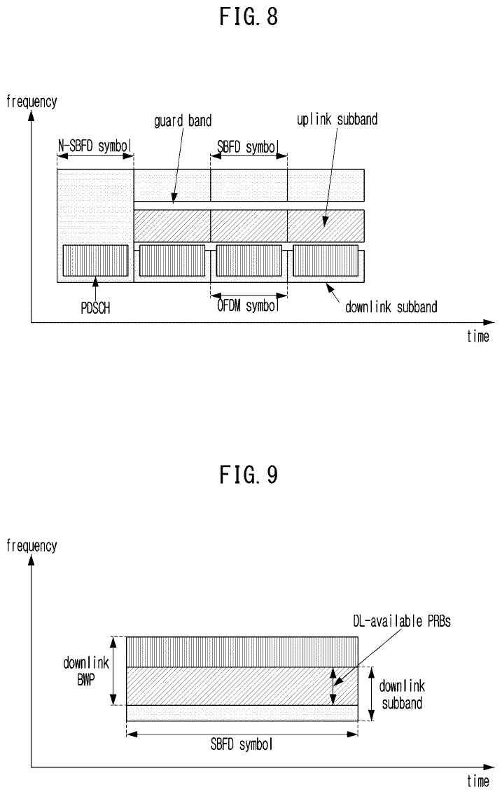

FIG. 8 is a conceptual diagram illustrating exemplary embodiments of a PDSCH scheduling scheme in a communication network.

Referring to FIG. 8, PDSCH scheduling may be performed across SBFD symbol(s) and N-SBFD symbol(s). PDSCH scheduling for N-SBFD symbol(s) may be scheduling for PDSCH transmission within an activated downlink BWP. PDSCH scheduling for N-SBFD symbol(s) may be scheduling for PDSCH transmission within a downlink BWP. The PDSCH scheduling for SBFD symbol(s) may be scheduling for PDSCH transmission within a downlink subband and PDSCH transmission outside a downlink subband.

Among frequency resources of the downlink subband, a region included in the downlink BWP may correspond to DL-available PRBs. The downlink BWP may be an activated downlink BWP. Among frequency resources of an uplink subband, a region included in an uplink BWP may correspond to UL-available PRBs. The uplink BWP may be an activated uplink BWP. The DL-available PRBs may be defined as an overlapping region between the downlink BWP and the downlink subband of SBFD symbols. The UL-available PRBs may be defined as an overlapping region between the uplink BWP and the uplink subband of SBFD symbols. The DL-available PRBs may be configured in SBFD symbols based on an instruction of the base station within the downlink BWP. The UL-available PRBs may be configured in SBFD symbols based on an instruction of the base station within the uplink BWP.

FIG. 9 is a conceptual diagram illustrating exemplary embodiments of DL-available PRBs in SBFD symbols in a communication network.

Referring to FIG. 9, a downlink BWP may exist in the frequency domain. A downlink subband of SBFD symbols may exist in the frequency domain. An overlapping region between the downlink BWP and the downlink subband may exist in the frequency domain, and the overlapping region may be defined as DL-available PRBs.

A base station may schedule one or more PDSCH transmissions using one DCI. When the base station schedules one or more PDSCH transmissions using one DCI, the terminal may receive PDSCH(s) in the one or more slots. The PDSCHs may be transmitted in symbols (e.g., OFDM symbols) having the same time position (e.g., the same symbol indexes) within each slot. When the SBFD transceiving configuration 1 is indicated to the terminal, and one or more PDSCH transmissions are scheduled to the terminal using one DCI, the terminal may receive PDSCH in SBFD symbols or N-SBFD symbols within each slot. The terminal may receive one or more PDSCHs scheduled using one DCI. In this case, the terminal may determine a symbol type (e.g., SBFD symbol or N-SBFD symbol) of the one or more PDSCHs received based on a symbol type (e.g., SBFD symbol or N-SBFD symbol) of the first PDSCH received through the one DCI. The symbol type of the first PDSCH received may be a symbol type of the first PDSCH occasion (e.g., the first PDSCH reception occasion). The first PDSCH may be the earliest PDSCH among the PDSCHs in the time domain. For example, when the first PDSCH among one or more PDSCHs scheduled through the one DCI is scheduled in SBFD symbols, the terminal may receive the one or more PDSCHs in SBFD symbols. For example, when the first PDSCH among one or more PDSCHs scheduled through the one DCI is scheduled in N-SBFD symbols, the terminal may receive the one or more PDSCHs in N-SBFD symbols.

In another exemplary embodiment, when the SBFD transceiving configuration 2 is indicated to the terminal and one or more PDSCH transmissions are scheduled to the terminal using one DCI, the terminal may receive one or more PDSCHs using SBFD symbols or N-SBFD symbols. In the frequency domain, a downlink region of N-SBFD symbols and a downlink subband region of SBFD symbols may be different. For example, a size and/or a position of the downlink region of N-SBFD symbols may differ from a size and/or a position of the downlink subband region of SBFD symbols in the frequency domain.

When the SBFD transceiving configuration 1 is indicated to the terminal and the terminal receives one or more PDSCHs scheduled using one DCI, the terminal may receive PDSCH(s) using scheduled PRBs that exist within downlink PRBs. When the terminal receives one or more PDSCHs scheduled using one DCI, the terminal may determine a number of PRBs for determining a TBS of PDSCH as a number of PRBs that exist within DL-available PRBs among the scheduled PRBs.

When the SBFD transceiving configuration 2 is indicated to the terminal and the terminal receives one or more PDSCHs scheduled using one DCI, the terminal may determine a number of PRBs for determining a TBS of PDSCH differently for SBFD symbols and N-SBFD symbols. When the terminal receives a PDSCH in SBFD symbols within a slot, the terminal may determine a number of PRBs for deciding a TBS of PDSCH as a number of PRBs that exist within DL-available PRBs among the scheduled PRBs. When the terminal receives a PDSCH in N-SBFD symbols within a slot, the terminal may determine a number of PRBs for determining a TBS of PDSCH as a number of the scheduled PRBs.

The base station may schedule repeated PDSCH transmission. When the base station schedules repeated PDSCH transmission, the terminal may receive PDSCH(s) in one or more slots. The PDSCHs may be transmitted in symbols (e.g., OFDM symbols) having the same time position (e.g., the same symbol indexes) within each slot. When the SBFD transceiving configuration 1 is indicated to the terminal and repeated PDSCH transmission is scheduled in one or more slots, the terminal may receive PDSCHs in SBFD symbols or N-SBFD symbols within each slot.

The terminal may receive one or more PDSCHs based on repeated PDSCH transmission scheduling. In this case, the terminal may determine a symbol type for the one or more PDSCH receptions based on a symbol type (e.g., SBFD symbol or N-SBFD symbol) for the first PDSCH reception (e.g., the first PDSCH occasion) indicated through DCI scheduling the PDSCH repetitions. For example, when the first PDSCH among one or more PDSCHs indicated through the repeated PDSCH transmission scheduling is scheduled in SBFD symbols, the terminal may receive the one or more PDSCHs in SBFD symbols. When the first PDSCH among the one or more PDSCHs indicated through the repeated PDSCH transmission scheduling is scheduled in N-SBFD symbols, the terminal may receive the one or more PDSCHs in N-SBFD symbols.

In another exemplary embodiment, when the SBFD transceiving configuration 2 is indicated to the terminal and repeated PDSCH transmission is scheduled in one or more slots, the terminal may receive PDSCH using SBFD symbol(s) or N-SBFD symbol(s). In the frequency domain, a downlink region of N-SBFD symbols and a downlink subband region of SBFD symbols may be different from each other. For example, a size and/or a position of the downlink region of N-SBFD symbols may differ from a size and/or a position of the downlink subband region of SBFD symbols in the frequency domain.

When the SBFD transceiving configuration 1 is indicated to the terminal and the terminal receives DCI scheduling repeated PDSCH transmission, the terminal may receive PDSCH using scheduled PRBs that exist within downlink PRBs. When the terminal receives one or more PDSCHs scheduled using one DCI, the terminal may determine a number of PRBs for determining a TBS of PDSCH as a number of PRBs that exist within DL-available PRBs among the scheduled PRBs.

When the SBFD transceiving configuration 2 is indicated to the terminal and the terminal receives DCI scheduling repeated PDSCH transmission, the terminal may determine a number of PRBs for determining a TBS of PDSCH. For example, the terminal may determine a number of PRBs for determining a TBS differently based on a symbol type (e.g., SBFD symbol or N-SBFD symbol) in which the first PDSCH is received within a slot. When the terminal receives the first PDSCH during the repeated PDSCH transmission in SBFD symbols, the terminal may determine a number of PRBs for determining a TBS of PDSCH as a number of PRBs that exist within DL-available PRBs among the scheduled PRBs. When the terminal receives the first PDSCH during the repeated PDSCH transmission in N-SBFD symbols, the terminal may determine a number of PRBs for determining a TBS of PDSCH as a number of the scheduled PRBs. When repeated PDSCH transmission is scheduled, the terminal may commonly apply a scheme of determining a number of PRBs for determining a TBS to the repeated PDSCH(s). For example, when NPDSCH repetitions are scheduled, the terminal may determine a number of PRBs for determining a TBS for the N PDSCH transmissions to be the same. The number of PRBs for TBS determination may vary according to a symbol type in which the first PDSCH transmission among the N PDSCH transmissions is performed. N may be a natural number.

In another exemplary embodiment, the terminal may determine a number of PRBs for determining a TBS of PDSCH to be different for SBFD symbols and N-SBFD symbols. When the terminal receives PDSCH in SBFD symbols within a slot, the terminal may determine a number of PRBs for determining a TBS of PDSCH as a number of PRBs that exist within DL-available PRBs among scheduled PRBs. When the terminal receives PDSCH in N-SBFD symbols within a slot, the terminal may determine a number of PRBs for determining a TBS of PDSCH as a number of the scheduled PRBs.

In another exemplary embodiment, the terminal may determine a number of PRBs for determining a TBS of PDSCH as a number of scheduled PRBs. In another exemplary embodiment, the terminal may determine a number of PRBs for determining a TBS of PDSCH as a number of PRBs that exist within DL-available PRBs among scheduled PRBs. In another exemplary embodiment, the terminal may determine a number of PRBs for determining a TBS of PDSCH as a number of PRBs that exist within DL-available PRBs among PRBs scheduled for the first PDSCH transmission. In another exemplary embodiment, the terminal may determine a number of PRBs for determining a TBS of PDSCH as a number of PRBs scheduled for the first PDSCH transmission.

The base station may schedule one or more PDSCH transmissions using SPS. When the base station schedules one or more PDSCH transmissions using SPS, the terminal may receive PDSCH(s) in one or more slots. The PDSCHs may be transmitted in symbols (e.g., OFDM symbols) having the same time position (e.g., the same symbol indexes) within each slot. When the SBFD transceiving configuration 1 is indicated to the terminal and one or more PDSCH transmissions are scheduled to the terminal using SPS, the terminal may receive PDSCH in SBFD symbol(s) or N-SBFD symbol(s) within each slot.

When the terminal receives one or more PDSCHs scheduled through SPS, the terminal may determine a symbol type in which the one or more PDSCHs are received according to a symbol type (e.g., SBFD symbol or N-SBFD symbol) of the first PDSCH received based on DCI for activation of the SPS. For example, when the first PDSCH among the one or more PDSCHs scheduled through the SPS and activated by the activation DCI is scheduled in SBFD symbols, the terminal may receive the one or more PDSCHs in SBFD symbols. For example, when the first PDSCH among the one or more PDSCHs scheduled through the SPS and activated by the activation DCI is scheduled in N-SBFD symbols, the terminal may receive the one or more PDSCHs in N-SBFD symbols.

In another exemplary embodiment, when the SBFD transceiving configuration 2 is indicated to the terminal and one or more PDSCH transmissions are scheduled to the terminal using SPS, the terminal may receive PDSCH(s) using SBFD symbols or N-SBFD symbols. When one or more PDSCH transmissions are scheduled to the terminal using SPS, the terminal may receive PDSCH in SBFD symbols or N-SBFD symbols within each slot. In the frequency domain, a downlink region of N-SBFD symbols and a downlink subband region of SBFD symbols may be different from each other. For example, a size and/or a position of the downlink region of N-SBFD symbols may differ from a size and/or a position of the downlink subband region of SBFD symbols in the frequency domain.

When the SBFD transceiving configuration 1 is indicated to the terminal and one or more PDSCH transmissions are scheduled to the terminal using SPS, the terminal may receive PDSCH transmission(s) using SBFD symbols or N-SBFD symbols. The terminal may receive the PDSCH transmission(s) using one symbol type. The terminal may determine the one symbol type for PDSCH reception among SBFD symbol or N-SBFD symbol. To determine the symbol type, the terminal may use the first PDSCH based on activation of the SPS. When the terminal receives the first PDSCH based on the SPS in SBFD symbols, the terminal may receive the PDSCH transmission(s) based on the SPS in SBFD symbols. When the terminal receives the first PDSCH based on the SPS in N-SBFD symbols, the terminal may receive the PDSCH transmission(s) based on the SPS in N-SBFD symbols.

When the SBFD transceiving configuration 1 is indicated to the terminal and one or more PDSCH transmissions are scheduled to the terminal using SPS, the terminal may receive PDSCH using scheduled PRBs within downlink PRBs. When the terminal receives one or more PDSCHs using SPS, the terminal may determine a number of PRBs for determining a TBS of PDSCH as a number of PRBs that exist within DL-available PRBs among scheduled PRBs.

When the SBFD transceiving configuration 2 is indicated to the terminal and the terminal receives one or more PDSCHs using SPS, the terminal may determine a number of PRBs for determining a TBS of PDSCH to be different for SBFD symbols and N-SBFD symbols. The terminal may determine a number of PRBs for determining a TBS of PDSCH for SBFD symbols as a number of PRBs that exist within DL-available PRBs among scheduled PRBs. The terminal may determine a number of PRBs for determining a TBS of PDSCH for N-SBFD symbols as a number of scheduled PRBs.

In another exemplary embodiment, the terminal may determine a number of PRBs for determining a TBS of PDSCH as a number of scheduled PRBs. In another exemplary embodiment, the terminal may determine a number of PRBs for determining a TBS of PDSCH as a number of PRBs that exist within DL-available PRBs among scheduled PRBs. In another exemplary embodiment, the terminal may determine a number of PRBs for determining a TBS of PDSCH as a number of PRBs that exist within DL-available PRBs among PRBs scheduled for the first PDSCH transmission. In another exemplary embodiment, the terminal may determine a number of PRBs for determining a TBS of PDSCH as a number of PRBs scheduled for the first PDSCH transmission.

When the SBFD transceiving configuration 2 is indicated to the terminal and repeated PDSCH transmission based on SPS is scheduled to the terminal, the terminal may determine a number of PRBs for determining a TBS of PDSCH. The terminal may determine a number of PRBs for determining a TBS differently based on a symbol type in which the first PDSCH transmission is received within a slot. When the terminal receives the first PDSCH transmission during the repeated PDSCH transmission in SBFD symbols, the terminal may determine a number of PRBs for determining a TBS of PDSCH as a number of PRBs that exist within DL-available PRBs among scheduled PRBs. When the terminal receives the first PDSCH transmission during the repeated PDSCH transmission in N-SBFD symbols, the terminal may determine a number of PRBs for determining a TBS of PDSCH as a number of the scheduled PRBs.

When repeated PDSCH transmission is scheduled, the terminal may commonly apply a method of determining a number of PRBs for determining a TBS to the repeated PDSCH(s). For example, when N PDSCH repetitions are scheduled, the terminal may determine a number of PRBs for determining TBSs for the N PDSCH repetitions to be the same. The number of PRBs for determining the TBS may vary according to a symbol type in which the first PDSCH transmission among the N PDSCH repetitions is performed. N may be a natural number.

The base station may transmit to the terminal, through signaling (e.g., system information, higher-layer message, RRC configuration), time resource configuration information (e.g., time domain resource configuration information, time region resource configuration information) including information indicating a symbol type (e.g., SBFD symbol or N-SBFD symbol). The terminal may receive the time resource configuration information based on the signaling of the base station and may identify the symbol type based on the time resource configuration information. The terminal may receive PDSCH based on the symbol type (e.g., SBFD symbol or N-SBFD symbol).

Independent resource allocation may be performed respectively for SBFD symbol(s) and N-SBFD symbol(s). For example, independent PDSCH scheduling may be performed respectively for SBFD symbol(s) and N-SBFD symbol(s). The independent PDSCH scheduling may have a different frequency resource configuration. Scheduling information for SBFD symbol(s) may be defined as SBFD scheduling information. Scheduling information for N-SBFD symbol(s) may be defined as N-SBFD scheduling information. Frequency resources for the SBFD symbol(s) and frequency resources for the N-SBFD symbol(s) may be configured to be different from each other. The terminal may receive independent scheduling information respectively for the SBFD symbol(s) and the N-SBFD symbol(s) from the base station. The terminal may determine whether a symbol is an SBFD symbol or an N-SBFD symbol. When the symbol is an SBFD symbol, the terminal may perform PDSCH reception using the SBFD scheduling information. When the symbol is an N-SBFD symbol, the terminal may perform PDSCH reception using the N-SBFD scheduling information.

In another exemplary embodiment, the base station may transmit to the terminal, through signaling, scheduling information for SBFD symbol(s) and a frequency offset (e.g., a frequency resource offset value) for N-SBFD symbol(s). In this case, the frequency offset may be indicated toward a higher frequency direction. Alternatively, the base station may transmit to the terminal, through signaling, scheduling information for N-SBFD symbol(s) and a frequency offset (e.g., a frequency resource offset value) for SBFD symbol(s). In this case, the frequency offset may be indicated toward a lower frequency direction. The terminal may interpret frequency domain resource allocation (FDRA) information among the scheduling information by utilizing the frequency offset. The terminal may interpret an RIV, which is the FDRA information, by utilizing the frequency offset. The terminal may interpret the scheduling information (e.g., FDRA information) of frequency resources differently based on the symbol type (e.g., SBFD symbol or N-SBFD symbol). The terminal may receive a PDSCH based on the above-described information.

In another exemplary embodiment, the terminal may identify a frequency region indicated through scheduling information and may determine whether to receive PDSCH based on the identified frequency region. For example, when a PDSCH frequency region indicated through PDSCH scheduling information for SBFD symbol(s) exists within DL-available PRBs, the terminal may receive PDSCH based on the PDSCH scheduling information. When the PDSCH frequency region indicated through the PDSCH scheduling information for SBFD symbol(s) does not exist within the DL-available PRBs, the terminal may not receive PDSCH based on the PDSCH scheduling information. Even when a part of the PDSCH frequency region indicated through the PDSCH scheduling information exists outside the DL-available PRBs, the terminal may determine that the PDSCH frequency region does not exist within the DL-available PRBs. The terminal may receive from the base station information indicating a symbol type (e.g., SBFD symbol or N-SBFD symbol). The terminal may receive from the base station information on the DL-available PRBs. For example, the terminal may identify the DL-available PRBs by using information on a downlink subband or activated downlink BWP of SBFD symbol(s). The terminal may determine whether to receive PDSCH based on the symbol type and the DL-available PRBs.

In another exemplary embodiment, the terminal may receive PDSCH in PDSCH resources existing within the DL-available PRBs among scheduled PDSCH resources. The terminal may perform rate matching for PDSCH resources that do not exist within DL-available PRBs among the scheduled PDSCH resources. The terminal may determine a TBS of PDSCH based on PRBs allocated through scheduling information. In another exemplary embodiment, the terminal may determine a TBS of PDSCH by using PRBs that exist within the DL-available PRBs among PRBs allocated through scheduling information. In another exemplary embodiment, when repeated PDSCH transmission is scheduled, the terminal may determine a TBS by using PRBs that exist within DL-available PRBs among PRBs allocated to the first PDSCH repetition.

Hereinafter, CSI-RS configuration and CSI reporting in SBFD symbols will be described. In SBFD symbols having one or more downlink subbands, CSI-RS resources may be configured. In SBFD symbols, the CSI-RS resources may be configured within a downlink subband. In SBFD symbols, the CSI-RS resources may be configured within DL-available PRBs. In SBFD symbols, the CSI-RS resources may be configured discontinuously. For example, the CSI-RS resources may not be configured in a guard band and/or in an uplink subband.

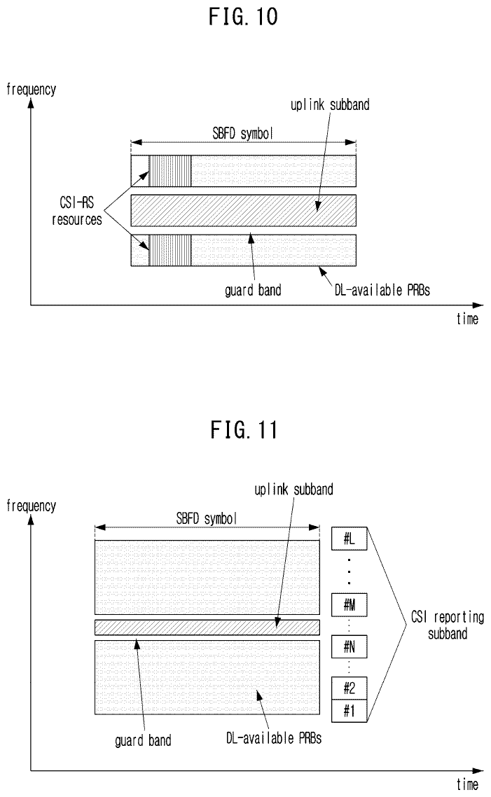

FIG. 10 is a conceptual diagram illustrating exemplary embodiments of CSI-RS resource configuration for SBFD symbols in a communication network.

Referring to FIG. 10, in SBFD symbols, a downlink subband, an uplink subband, and/or guard bands may be configured. CSI-RS resources for the SBFD symbols may be configured. The CSI-RS resources may be configured in the downlink subband or in DL-available PRBs. In the frequency domain, the CSI-RS resources may not be configured in the uplink subband and/or in the guard band.

In a frequency region of the SBFD symbols, one CSI-RS resource (e.g., continuous CSI-RS resource) may be configured. In this case, a CSI-RS resource that is not included in the DL-available PRBs may be punctured. CSI-RS resource configuration in the DL-available PRBs of the SBFD symbols may be the same as CSI-RS resource configuration in the same frequency resources of N-SBFD symbols. In other words, in the time domain, frequency resources of CSI-RS for the SBFD symbols and the N-SBFD symbols may be configured to be the same. For example, CSI-RS resource configuration for PRB #N within the DL-available PRBs of the SBFD symbols may be the same as CSI-RS resource configuration for PRB #N of the N-SBFD symbols. A CSI-RS sequence for PRB #N within the DL-available PRBs of the SBFD symbols may be configured to be the same as a CSI-RS sequence for PRB #N of the N-SBFD symbols. N may be a natural number.

Hereinafter, a CSI reporting subband in SBFD symbols will be described. The CSI reporting subband may be used for transmission of a CSI report. The terminal may perform CSI measurement by using CSI-RS resources configured in SBFD symbols. The terminal may report measured CSI to the base station. The terminal may perform CSI reporting in units of a CSI reporting subband. For example, the terminal may report CSI measurement results to the base station in units of a CSI reporting subband for CSI-RS frequency resources.

In the frequency domain, a size of one CSI reporting subband may vary according to configuration of the base station. The base station may transmit, to the terminal through signaling (e.g., higher-layer message or RRC configuration), information on a size of one CSI reporting subband. In another exemplary embodiment, a size of one CSI reporting subband may vary according to a size of a BWP. The BWP may be a downlink BWP. In another exemplary embodiment, candidate sizes of one CSI reporting subband may be determined based on a size of a downlink BWP, and one size among the candidate sizes of one CSI reporting subband may be indicated through signaling (e.g., higher-layer message or RRC configuration) of the base station. For example, a size of one CSI reporting subband may have a value of A or B according to the size of the downlink BWP. The base station may transmit to the terminal a signaling message (e.g., higher-layer message) indicating A or B. The terminal may determine a size of one CSI reporting subband based on the indication by the base station. The size of one CSI reporting subband may be determined in PRB units.

In another exemplary embodiment, candidate sizes of one CSI reporting subband may be determined based on a size of a downlink subband of SBFD symbols, and one size among the candidate sizes of one CSI reporting subband may be indicated through signaling (e.g., higher-layer message or RRC configuration) of the base station. In another exemplary embodiment, candidate sizes of one CSI reporting subband may be determined based on a number of DL-available PRBs of SBFD symbols, and one size among the candidate sizes of one CSI reporting subband may be indicated through signaling (e.g., higher-layer message or RRC configuration) of the base station.

The terminal may measure CSI for a CSI reporting subband and may report CSI measurement results to the base station. The terminal may perform CSI reporting for a CSI reporting subband that overlaps with DL-available PRBs of SBFD symbols. The terminal may not perform CSI reporting for a CSI reporting subband that exists outside DL-available PRBs of SBFD symbol(s).

Some PRBs of a CSI reporting subband may be located within DL-available PRBs, and remaining PRBs of the CSI reporting subband may not be located within the DL-available PRBs. In this case, the terminal may perform CSI measurement for the some PRBs of the CSI reporting subband and may report CSI measurement results to the base station. For example, CSI reporting subband #N may include P PRBs. Among the P PRBs, K PRBs may be located within DL-available PRBs, and the remaining P-K PRBs may not be located within the DL-available PRBs. Each of P and K may be a natural number, and P may be greater than K. The terminal may measure CSI for the K PRBs of CSI reporting subband #N and may report CSI measurement results (e.g., CSI measurement results for CSI reporting subband #N) to the base station.

FIG. 11 is a conceptual diagram illustrating exemplary embodiments of CSI reporting subband configuration for SBFD symbols in a communication network.

Referring to FIG. 11, CSI reporting subbands for SBFD symbols may be configured. A size of a CSI reporting subband may be determined based on at least one of a size of a downlink BWP, a size of a downlink subband, a size of DL-available PRBs, or a configuration of a base station. A terminal may measure CSI by using CSI-RS resources within the CSI reporting subband (e.g., CSI reporting subband #2) that is located within the DL-available PRBs among the CSI reporting subbands and may report CSI measurement results to the base station. The terminal may measure CSI for some PRBs with respect to the CSI reporting subbands (e.g., CSI reporting subbands #1, #N, #M, #L) that spans inside and outside the DL-available PRBs among the CSI reporting subbands and may report CSI measurement results to the base station. The some PRBs may be PRBs located within the DL-available PRBs. The CSI measurement results may be CSI measurement results for the CSI reporting subbands (e.g., the entire CSI reporting subbands).

The terminal may generate a CSI report based on periodic CSI-RS resources or semi-persistent CSI-RS resources. CSI-RS resources used for CSI determination (e.g., calculation) may be indicated to the terminal. The base station may instruct the terminal to generate CSI by using CSI-RS resources configured in one symbol type among SBFD symbol and N-SBFD symbol. The instruction may be transmitted to the terminal through signaling (e.g., higher-layer message or RRC configuration). The instruction may be transmitted to the terminal through a CSI report configuration. The terminal may generate CSI by using CSI-RS resources configured in SBFD symbol(s) or N-SBFD symbol(s) based on the instruction of the base station and may report the CSI to the base station. The terminal may not use CSI-RS resources configured in a symbol type that is not indicated by the base station for CSI generation. For example, when the base station instructs the terminal to generate CSI by using CSI-RS resources configured in SBFD symbol(s), the terminal may generate CSI by using CSI-RS resources belonging to SBFD symbol(s), and the terminal may not use CSI-RS resources belonging to N-SBFD symbol(s) for CSI generation.

Hereinafter, synchronization signal block (SSB) transmission and/or SSB reception in SBFD symbols will be described. The base station may transmit SSB in SBFD symbols. The terminal may receive SSB in SBFD symbols. In SBFD symbols, SSB may be transmitted within DL-available PRBs. The base station may transmit SSB within the DL-available PRBs of the SBFD symbols. The terminal may receive SSB within the DL-available PRBs of the SBFD symbols. The terminal may not receive SSB outside the DL-available PRBs of the SBFD symbols.

The base station or the terminal may transmit and receive DMRS. The base station may transmit DMRS for downlink transmission, and the terminal may receive DMRS from the base station. The terminal may transmit DMRS for uplink transmission, and the base station may receive DMRS from the terminal. DMRS may be transmitted or received in SBFD symbols. DMRS configuration in SBFD symbols may be the same as DMRS configuration in N-SBFD symbols. For example, a sequence for DMRS configuration in SBFD symbols may be the same as a sequence for DMRS configuration in N-SBFD symbols. DMRS transmission in SBFD symbols may be performed within DL-available PRBs or within UL-available PRBs. DMRS may not be transmitted outside the DL-available PRBs or the UL-available PRBs. DMRS that does not exist within the DL-available PRBs or the UL-available PRBs may be punctured. The base station may transmit DMRS within the DL-available PRBs, and the terminal may receive DMRS from the base station. The terminal may transmit DMRS within the UL-available PRBs, and the base station may receive DMRS from the terminal.

The methods according to the present disclosure may be implemented in the form of program instructions that can be executed through various computer means and may be recorded on a computer-readable medium. The computer-readable medium may include program instructions, data files, data structures, or a combination thereof. The program instructions recorded on the computer-readable medium may be specially designed and configured for the present disclosure or may be known and available to those skilled in the field of computer software.

Examples of the computer-readable medium include hardware devices specially configured to store and execute program instructions, such as read-only memory (ROM), random access memory (RAM), and flash memory. Examples of the program instructions include not only machine code generated by a compiler but also high-level language code that can be executed by a computer using an interpreter or the like. The above-described hardware devices may be configured to operate as at least one software module to perform the operations of the present disclosure, and vice versa.

Although the exemplary embodiments have been described above with reference to specific examples, it will be understood by those skilled in the art that various modifications and changes can be made to the present disclosure without departing from the spirit and scope of the present disclosure as defined in the following claims.

What is claimed is:

1. A method of a terminal, comprising:
receiving, from a base station, scheduling information for a plurality of physical downlink shared channels (PDSCHs) across subband full-duplex (SBFD) symbols and non-SBFD (N-SBFD) symbols in different slots;
determining a symbol type for the plurality of PDSCHs; and
receiving the plurality of PDSCHs from the base station based on one or more symbols having the symbol type in the different slots,
wherein the symbol type is SBFD symbol or N-SBFD symbol.

2. The method of claim 1, wherein each of the plurality of PDSCHs is not mapped to both SBFD symbol(s) and N-SBFD symbol(s) within one slot.

3. The method of claim 1, wherein the symbol type is determined based on an SBFD reception configuration 1 or an SBFD reception configuration 2, one symbol type for the plurality of PDSCHs in the different slots is determined based on the SBFD reception configuration 1, and one symbol type for at least one PDSCH among the plurality of PDSCHs in each of the different slots is determined based on the SBFD reception configuration 2.

4. The method of claim 3, wherein based on the SBFD reception configuration 2 not being configured for the terminal, the symbol type for the plurality of PDSCHs is determined based on the SBFD reception configuration 1.

5. The method of claim 3, wherein based on the symbol type for the plurality of PDSCHs being determined based on the SBFD reception configuration 1, the symbol type for the plurality of PDSCHs is determined as a symbol type of an occasion for a first PDSCH among the plurality of PDSCHs.

6. The method of claim 5, wherein the occasion for the first PDSCH is not mapped to both SBFD symbol(s) and N-SBFD symbol(s).

7. The method of claim 3, wherein based on the SBFD reception configuration 2 being configured for the terminal, the symbol type for the plurality of PDSCHs is determined based on the SBFD reception configuration 2.

8. The method of claim 1, further comprising receiving, from the base station, SBFD configuration information including at least one of time resource information or frequency resource information for SBFD symbol(s).

9. The method of claim 8, wherein the time resource information includes at least one of: an index of a start slot of an SBFD subband for SBFD symbols, an index of a start symbol of the SBFD symbols in the start slot, an index of an end slot of the SBFD subband, or an index of an end symbol of the SBFD symbols in the end slot.

10. The method of claim 8, wherein the frequency resource information includes at least one of: information on a position and a size of an uplink subband, information on a position and a size of a first SBFD subband for SBFD symbols, or information on a position and a size of a second SBFD subband for the SBFD symbols.

11. A method of a base station, comprising:
transmitting, to a terminal, scheduling information for a plurality of physical downlink shared channels (PDSCHs) across subband full-duplex (SBFD) symbols and non-SBFD (N-SBFD) symbols in different slots;
determining a symbol type for the plurality of PDSCHs; and
transmitting the plurality of PDSCHs to the terminal based on one or more symbols having the symbol type in the different slots,
wherein the symbol type is SBFD symbol or N-SBFD symbol.

12. The method of claim 11, wherein each of the plurality of PDSCHs is not mapped to both SBFD symbol(s) and N-SBFD symbol(s) within one slot.

13. The method of claim 11, wherein the symbol type is determined based on an SBFD reception configuration 1 or an SBFD reception configuration 2, one symbol type for the plurality of PDSCHs in the different slots is determined based on the SBFD reception configuration 1, and one symbol type for at least one PDSCH among the plurality of PDSCHs in each of the different slots is determined based on the SBFD reception configuration 2.

14. The method of claim 13, wherein based on the SBFD reception configuration 2 not being configured for the terminal, the symbol type for the plurality of PDSCHs is determined based on the SBFD reception configuration 1.

15. The method of claim 13, wherein based on the symbol type for the plurality of PDSCHs being determined based on the SBFD reception configuration 1, the symbol type for the plurality of PDSCHs is determined as a symbol type of an occasion for a first PDSCH among the plurality of PDSCHs.

16. The method of claim 15, wherein the occasion for the first PDSCH is not mapped to both SBFD symbol(s) and N-SBFD symbol(s).

17. The method of claim 13, wherein based on the SBFD reception configuration 2 being configured for the terminal, the symbol type for the plurality of PDSCHs is determined based on the SBFD reception configuration 2.

18. The method of claim 11, further comprising transmitting, to the terminal, SBFD configuration information including at least one of time resource information or frequency resource information for SBFD symbol(s).

19. The method of claim 18, wherein the time resource information includes at least one of: an index of a start slot of an SBFD subband for SBFD symbols, an index of a start symbol of the SBFD symbols in the start slot, an index of an end slot of the SBFD subband, or an index of an end symbol of the SBFD symbols in the end slot.

20. The method of claim 18, wherein the frequency resource information includes at least one of: information on a position and a size of an uplink subband, information on a position and a size of a first SBFD subband for SBFD symbols, or information on a position and a size of a second SBFD subband for the SBFD symbols.
